(19) United States
(12) Patent Application Publication
(10) Pub. No.: US 2006/0156635 A1
(43) Pub. Date: Jul. 20, 2006

(54) Abrasive particles, polishing slurry, and producing method thereof

(75) Inventors: Dae Hyeong Kim, Gyeonggi-Do (KR); Seok Min Hong, Gyeonggi-Do (KR); Yong Kuk Kim, Gyeonggi-Do (KR); Dong Hyun Kim, Seoul (KR); Myoung Won Suh, Gyeonggi-Do (KR); Jea Gun Park, Gyeonggi-Do (KR); Un Gyu Paik, Seoul (KR)

Correspondence Address: MARGER JOHNSON & MCCOLLOM, P.C., 210 SW MORRISON STREET, SUITE 400, PORTLAND, OR, 97204, US

(73) Assignees: K.C. TECH CO., LTD., Anseong-Si (KR); IUCF-HYU, Seoul (KR)

(21) Appl. No.: 11/305,535

(22) Filed: Dec. 16, 2005

(30) Foreign Application Priority Data
Dec. 16, 2004 (KR) 2004-0107276
Jul. 14, 2005 (KR) 2005-0063665

(51) Int. Cl. C09K 3/14

(52) U.S. Cl. 51/309

(57) ABSTRACT

Disclosed herein is a polishing slurry for use in an STI CMP process, necessary for fabricating ultra highly integrated semiconductors of 256 mega D-RAM or more (Design rule of 0.13 μm or less), which can polish wafers at a high removal rate, having an excellent the removal selectivity of oxide compared to nitride. The polishing slurry can be applied to various patterns required in the course of producing ultra highly integrated semiconductors, and thus excellent removal rate, removal selectivity, and within-wafer-nonuniformity (WIWNU), which indicates removal uniformity, as well as minimal occurrence of micro scratches, can be assured.

This application claims the priority of Korean Patent Application No. 10-2004-0107276, filed on Dec. 16, 2004 and 10-2005-0063665, filed on Jul. 14, 2005 in the Korean Intellectual Property Office, the disclosures of which are incorporated herein in their entirety by reference.

### BACKGROUND OF THE INVENTION

1. Field of the Invention

The present invention relates to a slurry for use in a chemical mechanical polishing (hereinafter, referred to as ‘CMP’) process. More particularly, the present invention relates to a polishing slurry for use in a shallow trench isolation (STI) CMP process, necessary for fabricating ultra highly integrated semiconductors of 256 mega D-RAM or more (Design rule of 0.13 μm or less), which can polish wafers at a high removal rate, having an excellent the removal selectivity of oxide compared to nitride, abrasive particles therefore, and methods for producing the abrasive particles and the polishing slurry.

2. Description of the Related Art

Chemical mechanical polishing (CMP) is a semiconductor processing technology in which a mechanical process, using abrasive particles between a pressed wafer and a polishing pad, and chemical etching, using a slurry, are simultaneously conducted, and has been an essential process of global planarization technology in the production of submicron-scaled semiconductor chips since the end of the 1980's when IBM Co., Ltd. developed it.

Polishing slurries are roughly classified into a slurry for oxide, a slurry for metal, and a slurry for poly-silicon according to the type of object to be polished. The slurry for oxide is used to polish an interlayer insulating film and a silicon oxide (SiO₂) layer employed in an STI (shallow trench isolation) process, and roughly comprises abrasive particles, deionized water, a pH stabilizer, and a surfactant. The abrasive particles function to mechanically polish the surface of the object by means of pressure from a polishing machine, and are exemplified by silica (SiO₂), ceria (CeO₂), and alumina (Al₂O₃).

Particularly, ceria slurry is frequently used to polish the silicon oxide layer during the STI process, and in this case, a silicon nitride layer is mainly used as a polishing stopper layer. Usually, an additive is added to the ceria slurry to reduce the removal speed of the nitride layer so as to improve the polishing speed selectivity of the oxide layer to the nitride layer. However, the use of the additive is disadvantageous in that the removal speed of the oxide layer, as well as the removal speed of the nitride layer, is reduced. Furthermore, the polishing agent of the ceria slurry typically has particles larger than those of the silica slurry, and therefore scratches the surface of the wafer.

However, if polishing speed selectivity of the oxide layer to the nitride layer is low, a dishing phenomenon, in which an excessive volume of the oxide layer is removed, occurs due to the loss of adjacent nitride layer patterns. Thus, it is impossible to achieve uniform surface flattening.

Accordingly, the slurry for STI CMP requires high selectivity and polishing speed, dispersion and micro-scratch stabilities, and narrow and uniform particle size distribution. Additionally, the number of large particles having sizes of 1 μm or more must be within a predetermined range.

With respect to conventional technology of producing the slurry for STI CMP, U.S. Pat. Nos. 6,221,118 and 6,343,976, granted to Hitachi Inc., disclose a method of synthesizing ceria particles and a method of producing a slurry having high selectivity using the same. These patents describe characteristics of particles required in the slurry for STI CMP, the type of additives containing polymer, and the production method using them in very critical and wide ranges. Particularly, the patents suggest wide ranges of an average grain size, an average primary particle size, and an average secondary particle size. Particularly, they mention a change of the grain size depending on calcination temperature, and scratches corresponding to this. In another conventional technology, U.S. Pat. No. 6,420,269, granted to Hitachi Inc., discloses a method of synthesizing various ceria particles and a method of producing a slurry having high selectivity using the same. Meanwhile, U.S. Pat. No. 6,615,499, granted to Hitachi Inc., discloses a change of ratios of peak intensities in a predetermined range of X-rays, which depends on the rate of temperature increase in a calcination process, and a change of removal rate according to this. Furthermore, in the prior arts, U.S. Pat. Nos. 6,436,835, 6,299,659, 6,478,836, 6,410,444, and 6,387,139, granted to Showa Denko Co. Ltd. in Japan, disclose a method of synthesizing ceria particles and a method of producing a slurry having high selectivity using the same. These patents mostly describe the types of additives added to the slurry, their effects, and a coupling agent.

However, the above prior arts disclose only the average particle size of the abrasive particles constituting the polishing slurry and the range thereof, but lack details on kinds and features of raw materials for abrasive particles, calcination processes taking such features into account, and properties of the ceria particles thus obtained.

Indeed, properties of the final ceria slurry product, including specific surface area, porosity, crystallinity, and uniformity of grain size distribution, may vary depending on material properties and calcination conditions, thus resulting in quite different STI CMP results. Particularly, as the design rule decreases, the numbers of macro abrasive particles and their agglomerates, which cause the important problematic micro scratches, change. Accordingly, it is very important to specify and restrict features of the raw material and the calcination process according to the features.

### SUMMARY OF THE INVENTION

Accordingly, the present invention has been made keeping in mind the above problems occurring in the prior art, and an object of the present invention is to provide a high performance nano ceria slurry which is capable of being applied in a process of producing ultra highly integrated semiconductors having a design rule of 0.13 μm or less, particularly, an STI process, and is capable of minimizing micro scratches, which are fatal to semiconductor devices, by properly employing a method and a device for pre-treating various particles, a dispersing device and a method of operating the dispersing device, a method of adding a chemical additive and an amount added, and a device for transferring samples.

Particularly, the present invention aims to provide abrasive particles in which the formation of large grains is prevented by controlling properties of cerium carbonate, a precursor material of ceria slurry, such as morphology, size distribution, agglomeration tendency, etc., and conducting a calcination process corresponding to the controlled properties of the precursor material so as to the size and crystallinity of the precursor material, a polishing slurry, prepared from the abrasive particles, which is capable of minimizing micro scratches, and methods for producing the abrasive particles and the polishing slurry.

Another object of the present invention is to provide a method of making agglomerated precursor materials uniform in size distribution through a multi-step calcination process.

In accordance with an aspect, the present invention provides a polishing slurry, comprising abrasive particles in which a particle size, compared to which 1% of the particles are smaller in the overall size distribution of a precursor material for the abrasive particles, ranges from 10 to 350 μm. In the polishing slurry, the abrasive particles in which a particle size, compared to which 50% of the particles are smaller in the overall size distribution of a precursor material for the abrasive particles, ranges from 4 to 100 μm.

Preferably, the particle size of the polishing slurry, compared to which 1% of the particles are smaller in the overall size distribution of a precursor material for the abrasive particles, ranges from 20 to 200 μm. Also preferably, the particle size of the polishing slurry, compared to which 50% of the particles are smaller in the overall size distribution of a precursor material for the abrasive particles, ranges from 5 to 40 μm.

In accordance with another aspect of the present invention, a method of producing abrasive particles for slurry, comprising: preparing a precursor material; and calcining the precursor material in at least two or more stages, is provided.

In the method, the calcining step comprises: primarily calcining the precursor material: pulverizing or crushing the primarily calcined precursor material to yield a smaller secondary precursor material; and secondarily calcining the secondary precursor material.

Preferably, the method may further comprises: pulverizing or crushing the secondarily calcined precursor material to form a tertiary precursor material; and thirdly calcining the tertiary precursor material.

In the method, the calcining step may be carried out at a temperature from 500 to 1,000° C.

In accordance with a further aspect of the present invention, a method for producing polishing slurry, comprising: preparing the abrasive particles produced above; milling the abrasive particles in a milling mixture comprising deionized water, a dispersing agent and an additive; and filtering the milling mixture to remove large particles therefrom.

In accordance with still a further aspect of the present invention, abrasive particles and the polishing slurry, produced by the methods described above, are provided.

The abrasive particles preferably comprise ceria and the precursor material preferably comprises cerium carbonate.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flow chart illustrating the production of a polishing slurry according to the present invention;

FIG. 2 is a flow chart illustrating the production of a precursor material according to the present invention;

FIG. 3 shows the definitions of D1, D50 and D99 depending on particle size;

FIG. 4 is a graph showing sizes of secondary particles of cerium carbonate;

FIG. 5 is a graph in which sizes of secondary particles of cerium carbonate are plotted against calcination temperatures;

FIG. 6a is a schematic view illustrating the formation of grains when calcining dispersed precursor materials;

FIG. 6b is a schematic view illustrating the formation of grains when calcining agglomerated precursor materials;

FIGS. 7a to 7c are TEM photographs of abrasive particles calcined at 800° C., having different sizes of secondary particles;

FIG. 8 is a conceptual view illustrating the calcination of the precursor material according to the present invention;

FIG. 9a is an SEM photograph of dispersed precursor materials;

FIG. 9b is an SEM photograph of agglomerated precursor materials;

FIG. 10 is a graph in which, when calcining dispersed and agglomerated precursor materials, densities and specific surface areas are plotted for the dispersed and the agglomerated precursor material against grain sizes;

FIG. 11a is a TEM graph of the slurry prepared from the dispersed precursor material;

FIG. 11b is a TEM graph of the slurry prepared from the agglomerated precursor material;

FIG. 12 is a graph showing grain sizes of slurries 1 and 2 before and after a milling process;

FIG. 13a is a graph showing a change in particle size distribution before and after the dispersion of slurry 1 with compulsion;

FIG. 13b is a graph showing a change in particle size distribution before and after the dispersion of slurry 2 with compulsion; and

FIG. 14 is a graph showing CMP results.

### DESCRIPTION OF THE PREFERRED EMBODIMENTS

Hereinafter, a process of producing a polishing slurry according to the present invention will be described in detail separately from the analysis of properties of the polishing slurry. Particularly, changes in the properties of the polishing slurry will be analyzed when agglomerates of the raw materials vary in size and when a multi-step calcination process is introduced, in separation. Furthermore, a description will be given of a method of producing the polishing slurry using ceria as a polishing agent, deionized water as a dispersion medium thereof, and an anionic polymer dispersing agent as a dispersing agent. Also, the CMP results, such as oxide film polishing speed and selectivity, depending on process conditions, will be given. Many modifications and variations of the present invention, which will be described later, are possible, and the scope of the present invention is not limited by the following description. [Production of Ceria Slurry]

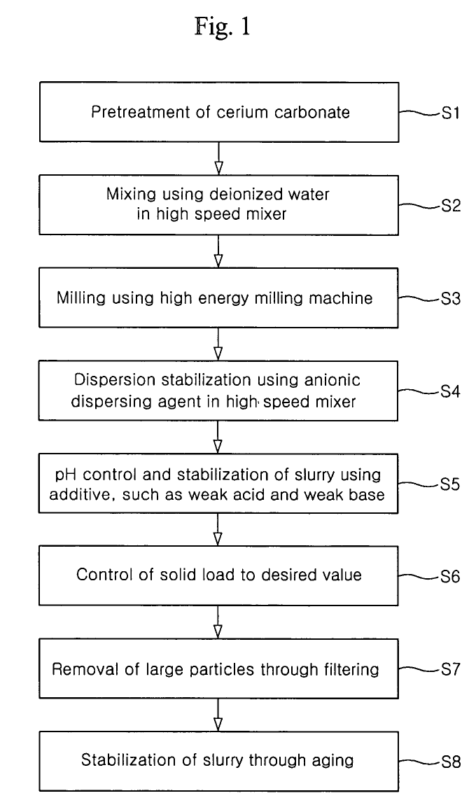

The ceria slurry of the present invention is prepared from ceria powder, deionized (DI) water, an anionic polymer dispersing agent, and an additive, such as a weak acid or weak base. A method of producing the polishing ceria slurry comprises the following steps (see FIG. 1). First, a precursor, such as cerium carbonate, is pre-treated. That is to say, it is synthesized in a solid phase to prepare the ceria powder (S1). Optionally, a multi-step calcination process, including drying, calcining, pulverizing, and/or crushing steps, may be conducted before the solid phase synthesis. The ceria powder is mixed and wetted with deionized (DI) water in a tank for mixing (S2), and the resulting mixture is milled using a milling machine so as to decrease the particle size and achieve distribution (S3). The anionic polymer dispersing agent is added to the slurry, which is produced according to the above procedure, to increase dispersion stability (S4), and the additive, such as the weak acid or weak base, is mixed with the mixture in a high speed mixer to control the pH. Subsequently, additional milling is conducted to stabilize the dispersion (S5) so that the weight ratio (wt %) of the slurry, that is, the solid load, is desirably set (S6), large particles are removed through filtering to prevent the occurrence of scratches during precipitation and polishing (S7), and additional aging is conducted, thereby the slurry is stabilized (S8). The method of producing the polishing ceria slurry according to the present invention will be stepwise described in detail.

1. Production of Ceria Powder

The first stage of the production of the ceria slurry according to the present invention is to produce the ceria powder from a precursor material through a solid-phase synthesis method. For example, the precursor, such as cerium carbonate, is calcined to generate the ceria powder, and a separate drying process may be conducted to remove moisture before the calcination. The dried precursor is excellent in terms of transferring and processibility. Depending on the properties of the precursor material, e.g., cerium carbonate, the ceria slurry may vary with respect to certain properties, including specific surface area, porosity, crystallinity, grain size distribution, etc., which is elucidated in detail below.

Properties of the ceria powder depend on the calcination conditions of cerium carbonate and the construction of a calcination device. Cerium carbonate has water of crystallization and adsorbed water, and water of crystallization typically has a valence of 4, 5, or 6. The calcination conditions depend on the number of water of crystallization and the amount of adsorbed water. After the calcination, water of crystallization and adsorbed water are removed. Thereafter, temperature and heat treatment are increased to cause decarbonation, in which a carbonate functional group is removed in the form of carbon dioxide. Thereby, ceria powder starts to be generated. Next, additional heat treatment is implemented to cause recrystalization, thereby creating ceria powder consisting of various sizes of particles. It is preferable that the calcination be conducted at 500-1000° C. Here, the calcination temperature determines the crystallinity as well as the grain size. The size of each grain or crystal increases with the calcination temperature.

This calcination may be achieved in multiple stages rather than a single stage, with pulverizing or crushing steps introduced therebetween. This multi-step calcination process may determine properties of the ceria slurry, such as specific surface area, porosity, crystallinity, grain size, etc., and the oxide removal rate and selectivity, which is also described in detail below.

2. Mixing and Milling

The ceria powder, which is produced through the calcination process as described above, is mixed and wetted with deionized water in a high speed mixer. Subsequently, the mixture is milled using a high energy milling machine to reduce the particle size and disperse particles, thereby producing a nano-sized ceria slurry. After the above mixing, it is preferable that particle size reduction and distribution be conducted using a high energy milling machine so as to control the particle size and to distribute agglomerated polishing particles. As well, the milling machine may be exemplified by a wet or dry milling machine. The dry milling machine is inferior to a wet milling machine in views of efficiency of particle pulverization, thus it is preferable to conduct the milling process using a wet milling machine comprising ceramic. Meanwhile, when using a wet milling process, precipitation and reduction of milling efficiency may occur, and the presence of large particles and a size distribution having a wide range may be likely, due to the agglomeration of particles, thus it is necessary to control the concentration of the polishing particles, to control the pH and conductivity, and to increase dispersion stability using a dispersing agent.

3. Dispersion Stabilization and Addition of an Additive

An anionic polymer dispersing agent is added to the slurry, and the additive, such as the weak acid or weak base, is added thereto to control a pH, thereby stabilizing the slurry. In connection with this, a mixture, which includes the dispersing agent and the additive, is milled using the high energy milling machine to reduce the particle size and to achieve dispersion. Next, the pulverized and dispersed slurry is transferred into a separate tank using a pump, and then dispersed again using an appropriate dispersing device to assure dispersion stability and prevent additional agglomeration and precipitation.

The anionic polymer compound, which is used as the dispersing agent, may be any one selected from the group consisting of polymethacrylic acid, polyacrylic acid, ammonium polymethacrylate, ammonium polycarboxylate, carboxyl-acryl polymer, and a combination thereof. The reason for this is that the slurry of the present invention is based on water and the above polymer compound is soluble in water at normal temperature. Furthermore, it is suitable that the content of the added anionic polymer compound be 0.0001-10.0 wt % based on the amount of polishing particles. It is preferable that the viscosity behavior of the stabilized ceria slurry be Newtonian behavior.

4. Control of Solid Load (wt %) and Removal of Large Particles

As described above, after a dispersion stabilization process of the slurry is completed, the solid load (wt %) of the ceria slurry is controlled within a desired range, and the large particles which may cause scratches during CMP and may cause precipitation and agglomeration are removed by filtering. When a great volume of the large particles exists, the gravitational force is larger than the dispersion force caused by the repulsive force between the particles, and surface areas of the large particles are smaller than those of the fine particles, thus dispersibility of the large particles is less than that of the fine particles. For the above two reasons, agglomeration and precipitation frequently occur, making the slurry unstable. Therefore, it is necessary to remove the large particles. Furthermore, the removal of the large particles increases as the number of repetitions of filtering for removing the large particles increases.

5. Aging of the Slurry

Stabilization of the slurry by aging is achieved by stirring the slurry in a tank for 24 hours so as to still further stabilize the slurry. This may be additionally conducted using the completed slurry, and may be omitted if necessary.

[Change of Properties of Ceria Slurry Depending on Properties of Precursor Material]

As in the following, in the case where ceria slurry is produced through the production process described above, the effect of the properties of the precursor material cerium carbonate on the properties of the ceria slurry is analyzed. Particularly, a detailed description will be given of changes of properties of ceria slurry with respect to the size of the agglomerated secondary particles of cerium carbonate.

As described above, abrasive particles are prepared by pre-drying and calcining precursor materials, and are then mixed with DI water before a milling process. In connection with the calcination, more extensive agglomeration of the precursor cerium carbonate results in wider particle size distribution. That is, upon calcination, fine ceria grains are produced along with large grains.

However, if it contains large grains having sizes larger than 1 μm, a polishing slurry may cause generation of micro scratches, which fatally affect semiconductor devices during the fabrication of ultra highly integrated semiconductors of 0.13 μm or less. Therefore, the exclusion of as many large grains as possible is a very important task for the production of ceria slurry. To this end, it is necessary to control the particle size and agglomeration of the precursor material cerium carbonate.

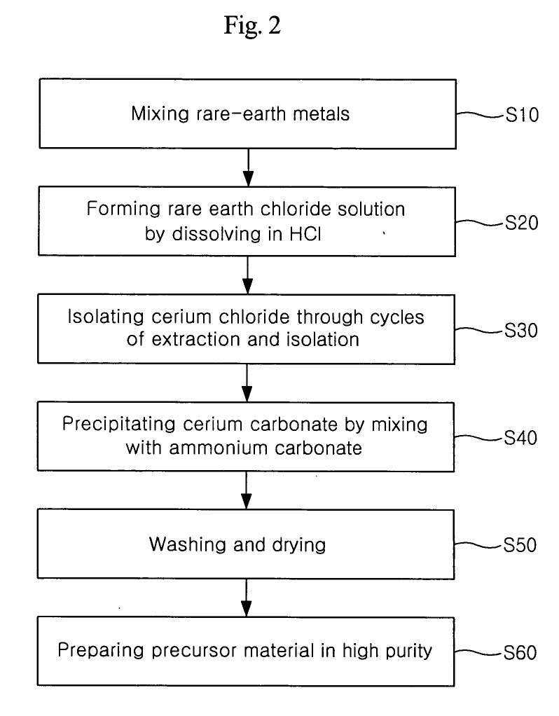

As the precursor material for ceria slurry, cerium carbonate is prepared according to the procedure shown in FIG. 2. To begin with, raw ores of rare-earth metals are mixed (S10) and solubilized in hydrochloric acid to give a rare earth chloride solution (S20). Many cycles of extraction and isolation lead to the division of cerium chloride from other rare-earth metals (S30). The cerium chloride is mixed with ammonium carbonate to form cerium carbonate as a precipitate (S50), which is then washed and dried (S50) to afford the desired precursor material having a high purity (S60).

When preparing the precursor material cerium carbonate using this co-precipitation method, the reaction conditions for precipitation, such as pH, temperature, time, etc., determine the properties of the precipitate. Particularly, the tendency of the precursor toward agglomeration upon precipitation, along with the resulting particle size of the precursor, has critical influence on properties of the final product ceria slurry.

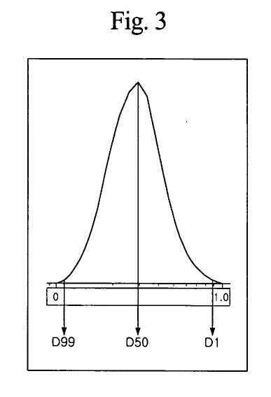

With reference to FIG. 3, there is a concept diagram that illustrates the definition of D1, D50 and D99, that is, classification of particles according to size.

As seen in FIG. 3, D50 corresponds to a particle size compared to which 50% of the particles are smaller in the overall size distribution, D1 to a particle size compared to which 1% of the particles are smaller, and D99 to a particle size compared to which 1% of the particles are larger. Hence, D1 accounts for a secondary particle size larger than do the other two. More extensive agglomeration and poorer dispersion stability bring about higher values for D1.

In order to better understand properties of ceria slurry depending on properties of the precursor material, examples of various particle size distributions are given below.

TABLE 1

| | D1 | D50 | D99 |
|---|---|---|---|
| | (large) | (medium) | (small) |
| Precursor material 1 | 365.3 μm | 120.5 μm | 2.4 μm |
| Precursor material 2 | 107.7 μm | 34.9 μm | 2.5 μm |
| Precursor material 3 | 51.9 μm | 6.483 μm | 1.5 μm |

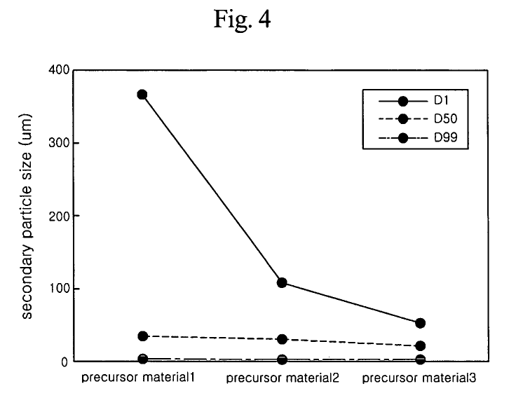

The particle size distributions of the precursor material cerium carbonate, given in Table 1, are plotted in FIG. 4. As can be seen, the precursor material 1 contains particles having larger sizes as a result of a higher degree of agglomeration, compared to the precursor material 2 or the precursor material 3. After calcination at high temperature, the cerium carbonate particles of the precursor materials 1 to 3 are found to have the grain sizes shown in FIG. 5, as measured using an X-ray diffractometer (XRD). For the reproduction of the data of FIG. 5, two grains were randomly selected from each precursor material and their sizes were measured. As is apparent in the figure, the grains increase in size with the calcination process being performed and with the particle size of the precursor material increasing.

During the calcination process, the cerium carbonate powder is produced while decarbonation occurs to remove a carbonate functional group in the form of carbon dioxide. At a higher calcination temperature, the cerium carbonate powder is recrystalized to generate larger sizes of grains. In addition, larger grain sizes are produced with the increase of the particle size due to the high tendency of cerium carbonate toward agglomeration. The reason for this is as follows.

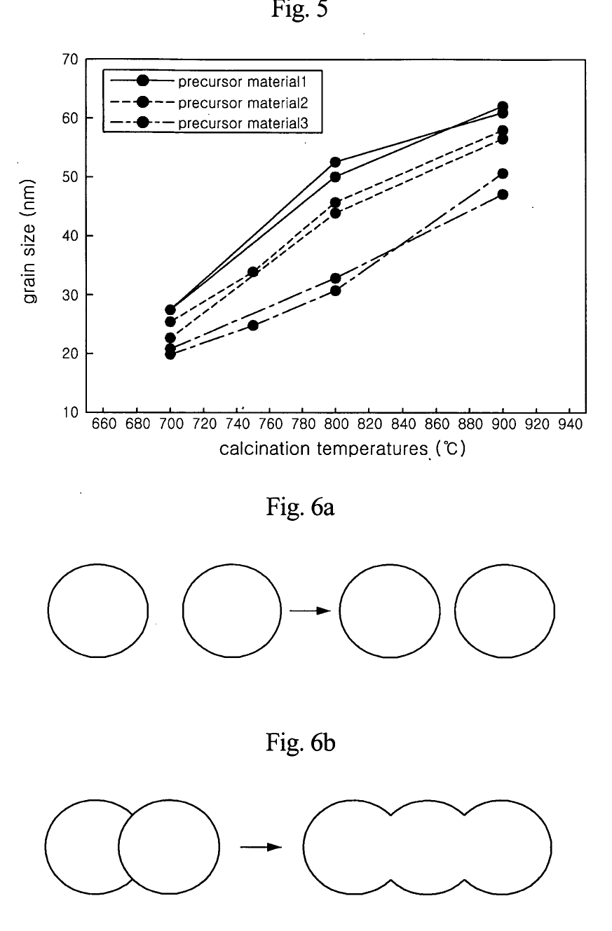

In very densely agglomerated nano-sized powder, many primary particles are in contact with each other. At the necking points between adjacent primary particles, mass diffusion and grid movement readily occur, so that large grains can be formed by thermal degradation even at low temperatures. That is, when particles are dispersed away from each other, as shown in FIG. 6a, they remain separated from each other even after calcination. In contrast, when particles are in contact with each other, as shown in FIG. 6b, calcination causes them to form a large grain centered at the necking point. Thus, different sizes of grains may be generated even though the calcination is performed at the same temperature for the same time period.

In the case of the precursor material 1 that has relatively large particle sizes due to the agglomeration of cerium carbonate, larger grains are formed, as shown in FIG. 5, resulting in the formation of abnormal grain growth of ceria abrasive particles.

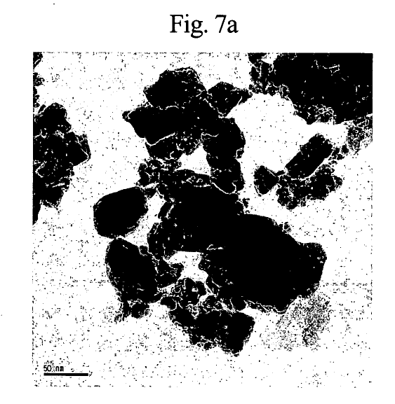

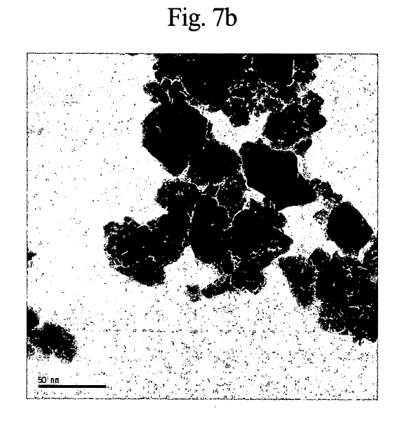

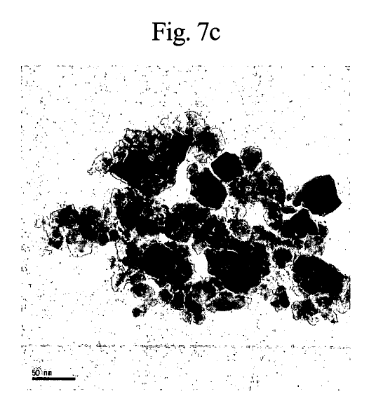

With reference to FIGS. 7a to 7c, there are TEM photographs that show the results of the calcination of the precursor materials 1 to 3 at 800° C., respectively. As seen in the photographs, the number of the large grains of the abrasive particles is understood to increase in proportion to the particle size of the precursor material cerium carbonate.

Meanwhile, when agglomerating, the precursor material appears as a large grain while very small particles may be formed inside the large agglomerate due to incomplete calcination. Agglomerated precursor materials show large resistance to mass transfer such that a delay occurs in the mass transfer and diffusion of the reaction gas oxygen and the by-product carbon dioxide, incurring incomplete calcination. A detail with regard to this will be described in the following section “change of properties of ceria slurry depending on multi-step calcination process.” For such a reason, as the precursor material particles agglomerate more extensively, they appear as larger grains, with fine grains formed therein, thus giving a broad particle size distribution.

In order to control the particle size of cerium carbonate, as mentioned above, it is necessary to minimize the agglomeration of the powder during the precipitation process of the method of producing the precursor material. Agglomeration occurs depending on the reaction condition for the preparation of the powder. As more uniform precipitation occurs, the cerium carbonate precipitates undergo less agglomeration. The uniform precipitation can be achieved by regulating the concentration of a CeCl₃ solution, a mixing rate, a reaction temperature and/or with a proper dispersing agent.

[Change of Properties of Ceria Slurry Depending on Multi-Step Calcination Process]

Herein, in the case where ceria slurry is produced using the process described above, the effect of a multi-step calcination process on the properties of the ceria slurry, especially in terms of CMP rate and the number of micro scratches, will be described in detail.

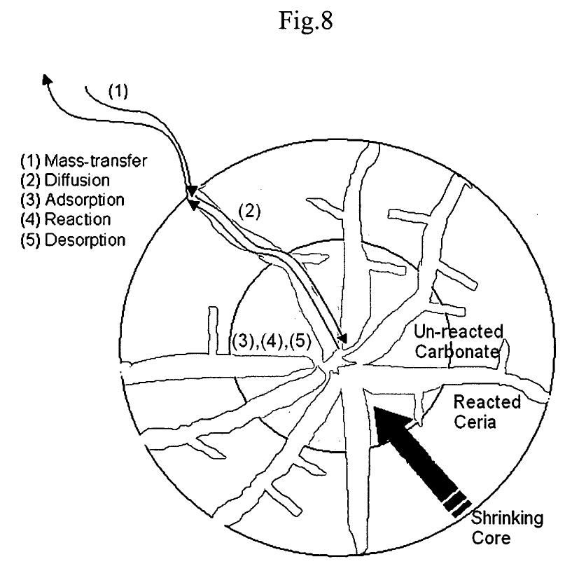

A calcination process, as shown in FIG. 8, consists of five steps. It starts with the mass transfer of oxygen from air to the cerium carbonate. Afterwards, the oxygen diffuses into the cerium carbonate through pores and is adsorbed on reaction sites. Next, the oxygen reacts to calcine the cerium carbonate. Thereafter, carbon dioxide, which is a product, is desorbed from the reaction sites and diffused through the pores out of the cerium carbonate into the air. This calcination process is represented by the following Reaction Formula 1.

$$Ce {CO}_{3} OH + \frac{1}{4} {O}_{2} \to {CeO}_{2} + {CO}_{2} + \frac{1}{2} {H}_{2} O \qquad [ Reaction Formula 1 ]$$

As can be understood, diffusion rates of oxygen and carbon dioxide through the pores during the calcination process are dependent on the morphology of the cerium carbonate, determining the overall reaction rate. Therefore, even though calcination is performed at the same temperature for the same time period, the resulting particles show differences in grain growth or crystallinity.

Particularly, there is a great difference in crystallinity between external and internal parts of the cerium carbonate agglomerates having a size of hundreds of μm, so that the grains show a broad distribution of particle sizes.

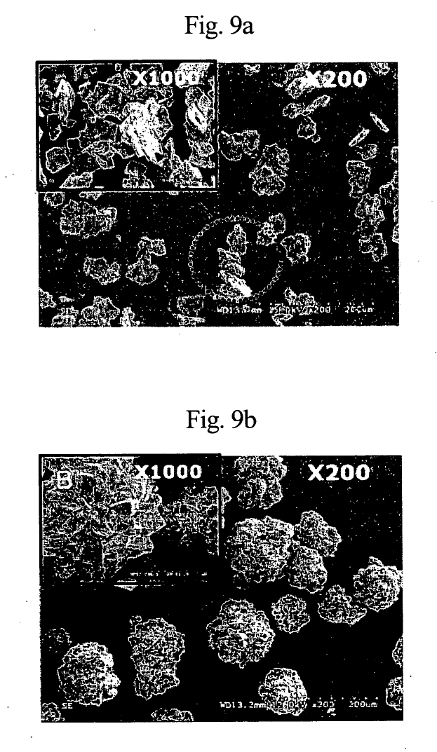

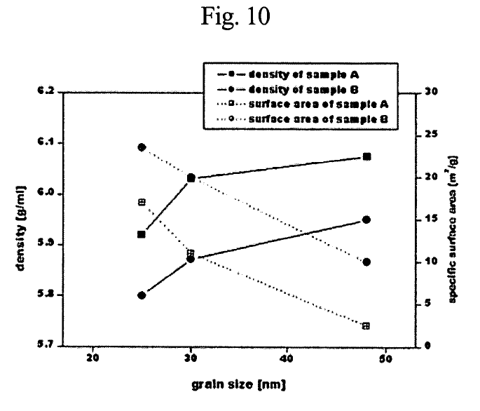

Referring to FIGS. 9a and 9b, there are SEM photographs of dispersed and agglomerated precursor materials, respectively. In FIG. 10, when calcining the dispersed precursor material and the agglomerated precursor material, densities and specific surface areas are plotted for the dispersed precursor material and the agglomerated precursor material against grain sizes, wherein samples A and B are obtained from the dispersed precursor material of FIG. 9a and the agglomerated precursor material of FIG. 9b, respectively. As is apparent in the plot, the agglomerated cerium carbonate has greater specific surface areas and lower densities than the dispersed cerium carbonate despite having the same grain size. This is attributed to the fact that, in the case of the cerium carbonate agglomerated as in FIG. 9b, its external portion is well crystallized, thereby appearing as large grains whereas its internal portion does not permit crystal growth due to the incomplete calcination, and thus shows low crystallinity.

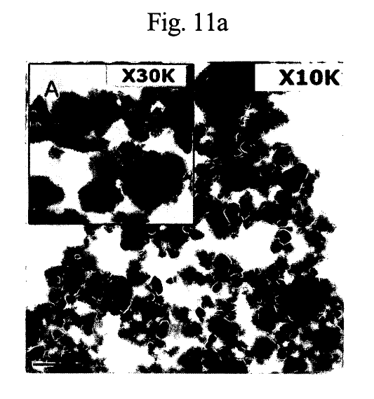

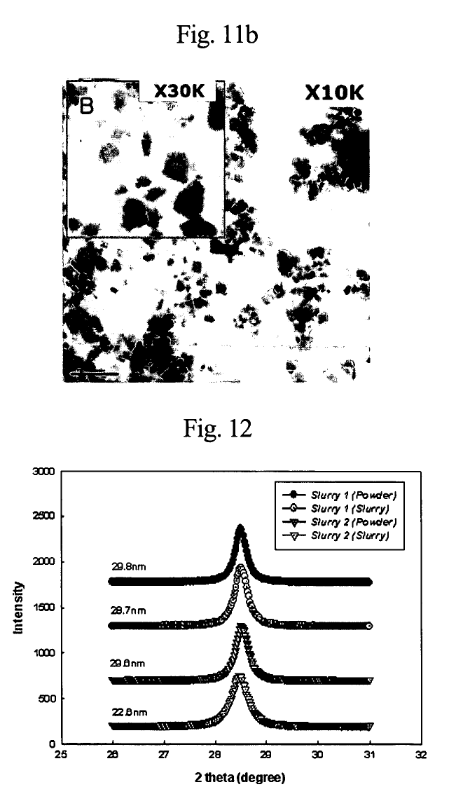

With reference to FIGS. 11a and 11b, slurries prepared by calcining the dispersed cerium carbonate and the agglomerate cerium carbonate are shown in respective TEM photographs. As can be seen, the slurry prepared from the agglomerated cerium carbonate shows a non-uniform particle size distribution, with many fine particles generated therein. This is ascribed to the incomplete crystallization within the precursor material. That is, the size distribution of grains of the agglomerated precursor material is increased because there is a large difference in size between internal and external grains, e.g., the external particles are large while the internal particles are small.

Moreover, the small particles generated inside the large grains readily agglomerate due to their large specific surface area and cause micro scratches together with the external large grains. Additionally, the small particles have poor oxide polishing rates due to the low internal crystallinity, thereby increasing the polishing speed selectivity of an oxide layer to a nitride layer.

Fatally affecting semiconductor devices during the fabrication of ultra highly integrated semiconductors of 0.13 μm or less, micro scratches have to be prevented. Taking into account the degree of agglomeration of the precursor material cerium carbonate, it is necessary to regulate the size of the grains.

To this end, the agglomerated cerium carbonate is uniformly calcined using a multi-step calcination process in accordance with the present invention. The difference in crystallinity between external and internal parts of the agglomerated cerium carbonate is overcome by the multi-step calcination of the present invention so as to produce uniform grain sizes of abrasive particles in a controlled manner.

First, a primary precursor material for cerium carbonate is dried and subjected to primary calcination. Next, pulverization or crushing gives a smaller secondary precursor material, exposing the internal parts, having low crystallinity, to the outside. A secondary calcination step is conducted on the pulverized or crushed secondary precursor material to afford abrasive particles.

The primary and the secondary calcination step may be conducted at the same or different temperatures. With regard to the pulverization or crushing process, various dry-pulverization or crushing apparatuses, such as a classifier, a crusher, an air jet mill, etc., may be utilized.

A further improvement may be obtained using a tri-step calcination process. In this regard, a step of pulverizing or crushing the precursor material is conducted just before a subsequent calcination step. In detail, after being primarily dried and calcined, a precursor material is pulverized and crushed to give a smaller secondary precursor material that has the internal part, having low crystallinity, exposed to the outside. After being subjected to secondary drying and calcination, the secondary precursor material is further pulverized or crushed into a far smaller tertiary precursor material that has the internal part having low crystallinity exposed to the outside. Finally, a tertiary drying and calcination step is conducted on the tertiary precursor material to afford abrasive particles.

In contrast to conventional single-step calcination processes, the multi-step calcination process allows external and internal parts of the agglomerated precursor material to have similar crystallinity and thus makes the grain sizes uniform in a narrow particle size distribution. Accordingly, large grains formed at the outside of the agglomerated precursor material, which cause the generation of micro scratches, can be broken into far smaller grains through the multi-step pulverization or crushing steps. In addition, crystallinity becomes uniform throughout the precursor material, so that calcination can produce abrasive particles having a narrow size distribution.

Crystallinity measurements of the abrasive particles prepared from the agglomerated cerium carbonate of FIG. 9b through the multi-step calcination process and through a single-step calcination process are given in Table 2, below. In Table 2, slurry 1 is obtained by conducting primary calcination, pulverization or crushing, and secondary calcination as in the multi-step calcination process while slurry 2 is obtained through a single-step calcination process. Grain sizes just after the calcination and after a wet milling process subsequent to the calcination were measured using an XRD.

TABLE 2

| | |
|---|---|
| Avg. Grain Size(nm) | Decreased |

| | Before Milling | After Milling | Amount(nm) |
|---|---|---|---|
| Slurry1 | 29.8 | 28.7 | 1.1 |
| Slurry2 | 29.6 | 22.6 | 7 |

As can be understood from Table 2 and FIG. 12, slurry 1, which is prepared through the multi-step calcination process, shows almost no change in grain size from just after the calcination to after the milling, whereas slurry 2, which is prepared through a single-step calcination process, shows a drastic decrease in grain size after the milling.

In X-ray diffraction, X-rays penetrate into a specimen only to a depth of 10 μm or less. However, as shown in FIG. 9b, the agglomerated cerium carbonate has a diameter as long as hundreds of μm and is maintained in such a form even after the single-step calcination as in slurry 2. Hence, when applying XRD to the agglomerate cerium carbonate, the external portion thereof can be measured and it is impossible to analyze the internal portion thereof. That is, XRD can be applied to the external grains, having high crystallinity, but not to the internal grains, having low crystallinity. After a wet-milling process has been conducted, XRD can analyze the smaller internal grains and, as a result, the average grain size was decreased by 7 nm.

In contrast, since the multi-step calcination process as in slurry 1 can sufficiently calcine the internal portion, the grains are uniform in size and their average size is reduced by as small as 1 nm even after the milling.

In addition, the grain size distribution has an influence on the dispersion stability of the resulting slurry. As a useful standard for measuring the agglomeration of the slurry, dD15 or dD50 may be used. That is to say, a particle size is measured using LA910, manufactured by Horiba, Inc., Japan, and the results are used to calculate them. Their definitions are as follows.
dD1=D1 without sonication−D1 with sonication
dD15=D15 without sonication−D15 with sonication
dD50=D50 without sonication−D50 with sonication

wherein, each term is as defined below.

D1 without sonication: D1 particle size measured without exposure to ultrasonic waves,

D1 with sonication: D1 particle size measured with exposure to ultrasonic waves,

D15 without sonication: D15 particle size measured without exposure to ultrasonic waves,

D15 with sonication: D15 particle size measured with exposure to ultrasonic waves,

D50 without sonication: D50 particle size measured without exposure to ultrasonic waves,

D50 with sonication: D50 particle size measured with exposure to ultrasonic waves.

In the case where the particle size is measured using an LA910 model manufactured by Horiba, Inc., if the measurement is conducted with ultrasonic waves, the agglomerated slurry is redistributed, so that it is possible to measure the particle size in a dispersed state. On the other hand, if the measurement is carried out without ultrasonic waves, the agglomerated slurry is not redistributed, thus the particle size of the agglomerated slurry is measured. Hence, the particle size variation, dD1, dD15, or dD50, increases with an increase in the agglomeration of the precursor material or with a decrease in the dispersion stability of the slurry.

Comparison of dispersion stability between application of the multi-step calcination process and the single-step calcination process to the agglomerated cerium carbonate of FIG. 9b is shown in Table 9b, below.

TABLE 3

| | dD1(nm) | dD15(nm) | dD50(nm) |
|---|---|---|---|
| Slurry 1 | 4 | 3 | 3 |
| Slurry 2 | 234 | 110 | 43 |

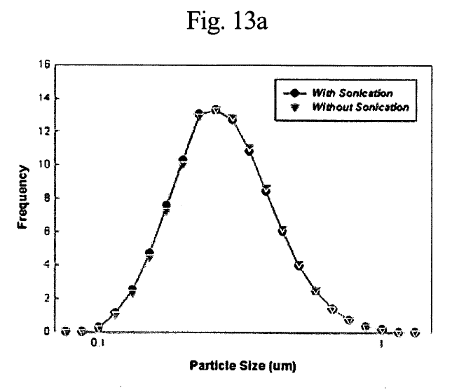

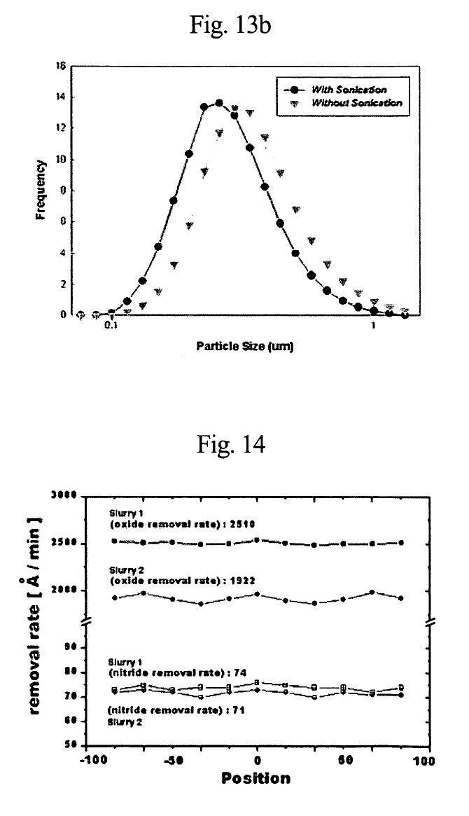

Based on the data, degrees of dispersion of slurries 1 and 2 were measured, and the results are given in FIGS. 13a and 13b, respectively. In FIG. 13a, slurry 1, which is prepared through the multi-step calcination process, shows no change in the particle size distribution of the secondary slurry particles, irrespective of the compulsive dispersion with ultrasonic waves. In contrast, slurry 2, which is prepared through the single-step calcination process, as shown in FIG. 13b, exhibits a large difference in the particle size distribution of secondary slurry particles before and after the compulsive dispersion. In slurry 2, small particles with large specific surface areas and large particles with small specific surface areas co-exist due to the difference in crystallinity between external and internal parts of the precursor material, so that the slurry has poor dispersion stability and extensive agglomerates. Accordingly, there is a great difference in particle size distribution between slurries in the presence of and the absence of compulsive dispersion.

[Change of CMP Properties]

In the following, ceria abrasive particles and slurry are produced from ceria powder in each predetermined condition through the above-mentioned method, and slurry properties, such as grain size and dispersion stability of each ceria slurry, and CMP properties, such as removal rate, micro scratches, etc., are analyzed.

First, analytical instruments for the properties are as follows.

1) Grain Size: measured using RINT/DMAX-2500 manufactured by Rigaku, Japan

2) Particle size distribution: measured using LA-910 manufactured by Horiba, Inc., Japan

3) TEM: measured using JEM-2010 manufactured by JEOL Ltd., Japan

Objects were polished using the ceria slurries produced as described above, and evaluated with respect to removal rate, the number of micro scratches, and removal selectivity. CMP polishing performance tests were carried out using 6EC, manufactured by Strasbaugh, Inc., U.S.A. An 8″ wafer, on which PE-TEOS (plasma enhanced chemical vapor deposition TEOS oxide) was applied to form an oxide film on the entire surface thereof, and another 8″ wafer, on which Si₃N₄ was applied to form a nitride film on the entire surface thereof, were used for the CMP polishing performance tests. Test conditions and substances used were as follows.

1) Pad: IC1000/SUBAIV (purchased from Rodel, Inc., U.S.A.)

2) Device for measuring a film thickness: Nano-Spec 180 (purchased from Nano-metrics, Inc., U.S.A.)

3) Table speed: 70 rpm

4) Spindle speed: 70 rpm

5) Down force: 4 psi

6) Back pressure: 0 psi

7) Amount of slurry supplied: 100 ml/min

8) Measurement of residual particles and scratches: measured using Surfscan SP1 manufactured by KLA-Tencor, Inc., U.S.A.

Wafers with an oxide film (PE-TEOS) or a nitride film (Si₃N₄) formed on the entire surface thereof, were polished for 1 min using the ceria slurries, after which the removal rates were determined from changes in thickness of the polished films and the micro scratches were measured using Surfscan SP1. The polishing performance of each slurry was tested in such a way that polishing characteristics were measured after a blank wafer was polished three times or more.

[Ceria Slurries 1 to 3: Comparison of Properties Depending on Particle Sizes of Precursor Material]

(1) Preparation of Ceria Abrasive Particles 1 to 3

Highly pure ceria powders 1 to 3 (respectively corresponding to precursor materials 1 to 3) were charged in respective containers in an amount of 800 g for each ceria powder, and calcined in a tunnel kiln at 800° C. for 4 hours. Ceria powders 1 to 3 have the same properties as the precursor materials 1 to 3 given in Table 1, respectively. All of ceria powders 1 to 3 were made of cerium carbonate, and had particle size distributions in decreasing order. The calcination was performed with temperature increasing at a rate of 5° C./min. After reaching the maximum temperature, the ceria powders were allowed to cool. Gas was made to flow at a rate of 20 m3/hour in the direction opposite to the direction of movement of a saggar in order to effectively remove the CO₂ by-product. The ceria powders 1 to 3 thus calcined were found to be highly pure ceria (cerium oxide) abrasive particles 1 to 3 when analyzed by an X-ray diffractometer.

(2) Preparation of Ceria Slurries 1 to 3

10 kg of each of highly pure ceria abrasive particles 1 to 3, which were respectively synthesized from ceria powders 1 to 3 under the above-mentioned conditions, was mixed with 90 kg of deionized water for 1 hour or more in a high speed mixer so as to achieve sufficient wetting, after which each of the 10% slurries thus obtained was milled using a pass-type milling process, which was intended to control particle sizes within a desired range and disperse agglomerated particles of the slurries. Subsequently, ammonium polymethacrylate, functioning as an anionic dispersing agent, was added in an amount of 1 wt % based on weight of the ceria powder. Mixing continued for 2 hours or longer, in consideration of adsorption, to disperse the slurries, followed by filtration to prepare ceria slurries 1 to 3.

(3) Comparison of Ceria Slurries 1 to 3

Analysis of ceria slurries 1 to 3, prepared respectively from highly pure ceria abrasive particles 1 to 3, indicated that the precursor material cerium carbonate, that is, the ceria powder, extensively agglomerates and that larger grain sizes lead to the formation of more abnormally enlarged grains in the ceria abrasive particles.

(4) CMP Test Results

Ceria slurries 1 to 3, prepared as described above, were tested for CMP polishing performance.

TABLE 4

| | Precursor | | | Removal | | | | Oxide film | |
|---|---|---|---|---|---|---|---|---|---|
| | Material | | | Rate on | | Removal ratio | | Residual | |
| Slurry | (nm) | | Grain | (Å/min) | | (oxide:nitride) | WIWNU | particles | Scratch |
| No. | D1 | D50 | Size | Oxide | Nitride | (selectivity) | (%) | (>0.20 μm, #) | (#) |
| 1 | 365.3 | 120.5 | 50.2 | 2750 | 54 | 50.9 | 1.1 | 420 | 5 |
| (C. Exp) | | | | | | | | | |
| 2 | 107.7 | 34.9 | 44.0 | 2682 | 52 | 51.6 | 1.1 | 293 | 2 |
| 3 | 51.9 | 6.483 | 30.7 | 2586 | 51 | 50.7 | 1.0 | 160 | 0 |

Using ceria slurries 1 to 3, which were prepared from ceria powders 1 to 3, that is, the precursor materials cerium carbonate having different grain sizes, CMP tests were carried out under the same CMP conditions, and the results are given in Table 4, above.

As can be understood from the data of Table 4, ceria slurry 1, prepared from a precursor material having D1 larger than 350 μm, exhibits a larger removal rate, but produces significantly more residual oxide film particles and therefore, more scratches than does ceria slurry 2 or 3. This is attributed to the fact that as the particle size of cerium carbonate increases, the grain size increases, which results in the formation of large grains, which cause micro scratches during a polishing process. On the other hand, a small DI of the precursor material reduces the number of oxide film residual particles and micro scratches, but decreases the removal rate, deteriorating the polishing performance.

A D50 exceeding 100 μm brings about a high removal rate, but produces a great number of oxide film residual particles as well as the scratches caused by the particles. Because D50 exceeding 100 μm means that more than 50% of the particles are larger than 100 μm, a high number of large particles are formed, causing micro scratches in proportion thereto. On the other hand, if the D50 of the precursor material is small, the removal rate decreases, resulting in poor polishing performance.

As illustrated above, the removal rate and the numbers of oxide film residual particles and scratches, which are very important factors in ultra highly integrated semiconductor processes, are dependent on particle sizes of the precursor material.

In contrast to the comparative example, ceria slurry 2 or 3, which were prepared from the precursor material cerium carbonate having properly controlled particle sizes, exhibited excellent removal rates while maintaining oxide film residual particles and micro scratches at significantly low levels.

Therefore, excellent removal ratios, polishing selectivity or removal rates and as few scratches as possible can be obtained by providing a precursor material having D1 ranging from 10 to 350 μm and D50 ranging from 4 to 100 μm. More preferably, the precursor material has D1 ranging from 20 to 200 μm and D50 ranging from 5 to 40 μm.

[Ceria Slurries 4 and 5: Comparison of Properties Depending on Calcination Conditions]

(1) Preparation of ceria abrasive Particles 4 and 5

Highly pure cerium carbonate powders 4 and 5 (both corresponding to the agglomerated precursor material of FIG. 9b) were charged in respective containers in an amount of 800 g for each ceria powder. First, cerium carbonate powder 4 was calcined twice in a tunnel kiln primarily at 750° C. for 4 hours and secondarily at 650° C. for an additional 4 hours, with pulverization conducted therebetween. On the other hand, cerium carbonate powder 5 was once calcined at 780° C. for 4 hours. In all cases, the calcination was performed in such a way that temperature was increased at a rate of 5° C./min. After reaching the maximum temperature, the cerium carbonate powder was allowed to cool. Gas was made to flow at a rate of 20 m³/hour in the direction opposite to the direction of movement of a saggar in order to effectively remove the CO₂ by-product. The ceria powder thus calcined was found to be highly pure ceria (cerium oxide) abrasive particles 4 and 5 having average grain sizes of 29.8 nm and 29.6 nm, respectively, as analyzed by an X-ray diffractometer.

(2) Preparation of Ceria Slurries 4 and 5

10 kg of each of highly pure ceria abrasive particles 4 and 5, which were respectively synthesized from ceria powders 4 and 5 under the above-mentioned conditions, was mixed with 90 kg of deionized water for 1 hour or more using a high speed mixer so as to achieve sufficient wetting, after which each of the 10% slurries thus obtained was milled using a pass-type milling process, which was intended to control particle sizes within a desired range and to disperse agglomerated particles of the slurries. Subsequently, ammonium polymethacrylate, functioning as an anionic dispersing agent, was added in an amount of 1 wt % based on the weight of the ceria powder. Mixing continued for 2 hours or longer in consideration of the adsorption thereof to disperse the slurries, followed by filtration to prepare ceria slurries 4 and 5.

(3) Comparison of Ceria Slurries 4 and 5

As is apparent from the data of Table 2 and FIG. 12, the analysis of ceria slurries 4 and 5, prepared respectively from highly pure ceria abrasive particles 4 and 5, indicated that ceria slurry 4 showed almost no change in grain size before and after milling, whereas ceria slurry 5 drastically decreased in grain size after milling. The reason is believed to reside in the fact that there is a large difference in grain size distribution between internal and external parts of the precursor cerium carbonate of ceria slurry 5 because the precursor cerium carbonate extensively agglomerates, forming externally large grains, while the internal part was not completely calcined.

In addition, ceria slurries 4 and 5 were analyzed for dispersion stability using a light scattering method with a particle size analyzer (LA-910, manufactured by Horiba). As shown in FIG. 13a, ceria slurry 4, which underwent the multi-step calcination process, showed no change in the particle size distribution of the secondary slurry particles, regardless of whether compulsive dispersion was conducted. In contrast, ceria slurry 5, which was prepared through the single-step calcination process, as shown in FIG. 13b, exhibited a large difference in the particle size distribution of secondary slurry particles before and after the compulsive dispersion. In ceria slurry 4, small internal particles and large external particles co-existed, so that the slurry is of poor dispersion stability and extensive agglomerates.

(4) CMP Test Results

Ceria slurries 4 and 5, prepared as described above, were tested for CMP polishing performance.

TABLE 5

| | | | | | Oxide film residual | |
|---|---|---|---|---|---|---|
| Slurry | Removal rate on (Å/min) | | | WIWNU | particles | Scratch |
| No | oxide | nitride | selectivity | (%) | (>0.20 μm, #) | (#) |
| 4 | 2332 | 49 | 47.6 | 1.1 | 440 | 3 |
| 5 | 2521 | 49 | 51.4 | 1.1 | 150 | 1 |
| (C. Exp) | | | | | | |

Data from Table 5 and FIG. 14 show that slurry 4, which was prepared through the multi-step calcination process, has sufficiently uniform crystallinity to remove oxide film at a high rate, while slurry 5 has poor crystallinity and a poor oxide removal rate, due to the incomplete calcination on the inside of the agglomerated cerium carbonate. In addition, as for a nitride film onto which a sufficient amount of surfactant is adsorbed electrically, its removal rate does not differ between slurry 4 and slurry 5, so that better removal selectivity can be achieved using slurry 4.

It is apparent that slurry 4 agglomerates to a lesser extent, in other words, disperses to a greater extent, and thus realizes far better planarity upon wafer polishing than does slurry 5, and that slurry 5 produces more oxide residual particles and micro scratches due to its agglomerates and large particles than does slurry 4.

Therefore, it is effective to apply the multi-step calcination process to realize excellent removal ratios, polishing selectivity or removal rates and a minimal number of micro scratches. In other words, desired properties of the slurry can be readily obtained by calcining the precursor material for ceria abrasive particles in a multi-step manner.

In consequence, a ceria slurry can be endowed with superior removal rate and selectivity and ability to cause no micro scratches, or a minimal number of micro scratches, by controlling the particle sizes of precursor materials for the ceria slurry within a predetermined range, in accordance with the present invention. Additionally, desired properties of the slurry can be readily obtained by controlling a calcination process in a multi-step manner.

As described hereinbefore, a polishing slurry which is superior with respect to various properties necessary for an STI CMP abrasive for use in semiconductor fabrication can be produced in accordance with the present invention. Particularly, when applying the polishing slurry according to the present invention, a significantly reduced number of scratches and residual particles, which may fatally affect the semiconductor devices, remains after CMP.

According to the present invention, a slurry capable of maintaining a high removal rate while decreasing the number of defect-causing scratches can be produced by conducting a calcination process in consideration of the properties of precursor materials.

As well, according to the present invention, it is possible to produce a slurry that has excellent physical properties essentially required of a polishing agent for STI CMP. As such, the polishing slurry of the present invention can be applied to various patterns required in the course of producing ultra highly integrated semiconductors, and thus excellent removal rate, removal selectivity, and within-wafer-nonuniformity (WIWNU), which indicates removal uniformity, as well as minimal occurrence of micro scratches, can be assured.

1. A polishing slurry, comprising:
abrasive particles in which a particle size, compared to which 1% of the particles are smaller in the overall size distribution of a precursor material for the abrasive particles, ranges from 10 to 350 μm.

2. The polishing slurry as set forth in claim 1, wherein the particle size, compared to which 1% of the particles are smaller in the overall size distribution of a precursor material for the abrasive particles, ranges from 20 to 200 μm.

3. A polishing slurry, comprising:
abrasive particles in which a particle size, compared to which 50% of the particles are smaller in the overall size distribution of a precursor material for the abrasive particles, ranges from 4 to 100 μm.

4. The polishing slurry as set forth in claim 3, wherein the particle size, compared to which 50% of the particles are smaller in the overall size distribution of a precursor material for the abrasive particles, ranges from 5 to 40 μm.

5. A polishing slurry, comprising:
abrasive particles, in which particle sizes compared to which 1% and 50% of the particles are smaller in the overall particle size distribution of a precursor material for the abrasive particles, range from 10 to 350 μm and from 4 to 100 μm, respectively.

6. The polishing slurry as set forth in claim 5, wherein the abrasive particles comprises ceria.

7. The polishing slurry as set forth in claim 5, wherein the precursor material comprises cerium carbonate.

8. A method of producing abrasive particles for slurry, comprising:
preparing a precursor material; and calcining the precursor material in at least two or more stages.

9. The method as set forth in claim 8, wherein the calcining comprises:
primarily calcining the precursor material:
pulverizing or crushing the primarily calcined precursor material to yield a smaller secondary precursor material; and
secondarily calcining the secondary precursor material.

10. The method as set forth in claim 9, further comprising:
pulverizing or crushing the secondarily calcined precursor material to form a tertiary precursor material; and
thirdly calcining the tertiary precursor material.

11. The method as set forth in claim 8, wherein the calcining is carried out at a temperature from 500 to 1,000° C.

12. The method as set forth in claim 8, wherein the abrasive particles comprise ceria.

13. The method as set forth in claim 12, wherein the precursor material comprises cerium carbonate.

14. A method for producing polishing slurry, comprising:
preparing the abrasive particles produced by the method of claim 8;
milling the abrasive particles in a milling mixture comprising deionized water, a dispersing agent and an additive; and
filtering the milling mixture to remove large particles therefrom.

15. Abrasive particles, produced by the method of claim 8.

16. A polishing slurry, produced according to claim 14.
